(19) United States
(12) Patent Application Publication
(10) Pub. No.: US 2011/0100186 A1
(43) Pub. Date: May 5, 2011

(54) CUTTING RULES FOR CUTTING OF FLAT MATERIALS

(76) Inventor: Anton Haas, Ardagger (AT)

(21) Appl. No.: 12/935,946

(22) PCT Filed: May 29, 2008
(86) PCT No.: PCT/EP2008/004280

§ 371 Date: Jan. 3, 2011

(30) Foreign Application Priority Data
Apr. 1, 2008 (DE) 10 2008 016 640.5

(51) Int. Cl. B26F 1/44

(52) U.S. Cl. 83/652

(57) ABSTRACT

The present invention relates to a cutting rule 1, comprising a steel band 10 with a cutting edge 20, a back 30 of the steel band 10 opposite to the cutting edge 20, wherein the back 30 comprises protrusions 32 which during the first use of the cutting rule 1 can be plastically deformed and wherein the protrusions 32 essentially comprise a height h of 30%-70% of the thickness D of the steel band 10. Further, the present invention relates to a cutting rule 1, comprising a steel band 10 with a cutting edge 20, a back 30 of the steel band 10 opposite to the cutting edge 20, wherein the back comprises protrusions 32 that can be plastically deformed during the use of the cutting rule 1 and wherein the protrusions 32 have been produced by grinding or milling of recesses 36 in transverse direction Q of the steel band into the back 30; as well as a cutting rule 1 whose back 30 is surface decarburized such that it can plastically deform during the first use of the cutting rule 1.

### 1. TECHNICAL FIELD

The present invention relates to cutting rules for cutting of flat materials, particularly paper, cardboard, plastics, etc. The expression cutting rules designates also special kinds like perforating rules or cutting-grooving-combination rules.

### 2. PRIOR ART

Cutting rules are known in the prior art and consist of a steel band with a cutting edge, two parallel side faces and a back opposite to the cutting edge. Cutting rules are bent corresponding to the desired shape of the piece to be cut, cut to a desired length and inserted into a carrier plate. The cutting tool made by this process is for example used for flat bed stamping for example in order to cut cardboard. Usually a flat bed stamping machine comprises a plane upper plate at which the cutting tool is mounted, as well as a plane lower plate by which the work piece is pressed against the cutting tool. The cutting tool comprises a carrier plate provided with slots, usually made of a wood composite, wherein the pre-bent cutting rules are inserted into these slots. The slots in the carrier plate are usually going through, such that the back of the cutting rule abuts the upper plate of the flat bed stamping machine.

In order to achieve an equal cutting result, the cutting rules must be adjusted in their height. Initially, a test cutting is performed and it is recognized at which regions the work piece is cut appropriately and at which regions no complete cut was done. At these regions, intermediate layers of paper or special metal or plastic bands are introduced between a back plate and the upper plate of the flat bed stamping machine in order to locally increase the pressure onto the cutting rules. This procedure is designated as levelling.

This levelling can be done for large areas (the so called “zone levelling”) or can be done only for special local areas in which an insufficient cutting appears (the so called “local levelling”). It is done on a levelling sheet which is a material layer that lies between a back plate behind the cutting rules and a protection plate of the upper plate of the flat bed stamping machine. Onto the levelling sheet for example smaller or larger pieces of the intermediate layers are manually fixed at particular positions. Test cuttings were done in between in order to evaluate the effects of the levelling. Therefore, the levelling is a time-consuming iterative process which requires much experience and in which the flat bed stamping machine cannot be productively used.

Since manual levelling is time-consuming and requires an expensive stop of the machine, there is a need for a method and means for decreasing this effort.

For doing so different possible solutions were proposed, among others, elastic-plastic deformable intermediate layers which are introduced behind the cutting tool or under the cutting plate in order to equalize the pressure differences. For example, the DE 33 17 777 C1 shows a system, in which the cutting rules on their back side comprise hardened edges, which may penetrate into such an intermediate plate during the stamping steps.

Further, for example, in the DE 199 13 216 C1 it was proposed to use cutting rules having a section-reduced area that compresses during the use of the cutting rule in order to automatically perform a height adaptation of the cutting rule.

Finally, in the DE 31 35 980 C1 it was proposed to use a cutting rule that has a deformable back, which should enable a self-regulating adjustment of the cutting rule. It is proposed to provide the back of the cutting rule on a large area of both sides with a chamfer, to provide teeth within the cross section of the back of the cutting rule, or to introduce lateral slots.

However, the proposed geometries have the disadvantage that they either not lead to the desired result in the desired amount or lead to an instability of the cutting rule, what leads not to a complete height levelling and an inaccurate cutting result. To this end, cutting rules having such shapes were not accepted by the market.

Further, the cross sections of cutting rules according the prior art would have been very costly in production what would make such rules very expensive. Further, an automatic processing, in particular an automatic bending of such rule cross sections, would not be possible, or not be possible without edge bulging.

Therefore, it is the problem of the present invention to provide a source material for cutting rules which on the one hand provides an automatic levelling and on the other hand does not have the disadvantages of known cutting rules of the prior art. Since cutting rules nowadays are mainly processed by machines, particularly bent, it must be guaranteed that a cutting rule embodiment allows such processing without damages.

### 3. SUMMARY OF THE INVENTION

The above-mentioned problems are solved by a cutting rule according patent claim 1, 4, or 6. Particularly, the above-mentioned problems are solved by a cutting rule, comprising a steel band with a cutting edge, a back of the steel band opposite to the cutting edge, wherein the back comprises protrusions that are plastically deformed during the first use of the cutting rule and wherein the protrusions essentially have a height h of 30%-70% of the thickness D of the steel band.

By means of calculations and tests it was found out that such a source material that comprises protrusions at its back that have a certain relationship of their height to the thickness of the steel band on the one hand provides an automatic height levelling of the cutting rule wherein on the other hand the stability of the cutting rule is not deteriorated. During the first use of a tool with such cutting rules, the protrusions which are loaded most are plastically deformed by means of the appearing local compression stress wherein an automatic levelling happens. Ideally, during the following load cycles of the tool the same compression stress is given on each section of the cutting line.

In a first preferred embodiment, the protrusions essentially comprise a height h of 40%-60% and more preferred of essentially 50% of the thickness D of the steel band. The best results with respect to stability and deformability were achieved if the protrusions comprise essentially a height h which lies in the range of the half thickness D of the steel band. Higher protrusions—that are suggested for example by the prior art—rather deform elastically, may uncontrollable tilt to the side, or the steel band tilts within the slot of the carrier plate.

In a further preferred embodiment, the protrusions were produced by milling or grinding of recesses into the back in transverse direction of the steel band. This milling or grinding preferably is done after the working of the cross section shape of the grooving or cutting rule.

In another aspect of the present invention, the above-mentioned problem is solved by a cutting rule comprising a steel band with a cutting edge, a back of the steel band opposite to the cutting edge, wherein the back comprises protrusions that plastically deform during the first use of the cutting rule and wherein the protrusions are generated by milling or grinding of recesses into the back in transverse direction of the steel band.

Surprisingly, it was found out that for such cutting rules during the bending no edge increase, respectively back bulging happens due to recesses transverse to the bending direction, since the back area is relieved due to the transverse extending recesses. This provides advantages with respect to the levelling, since also bent cutting rules remain their initial height and in total much less levelling is necessary. By means of the recesses arranged transverse to the steel band, therefore, also the height of the protrusions can be chosen smaller for an automatic levelling by plastic deformation.

Likewise, with such cutting lines, the highest loaded protrusions plastically deform during the first load of a tool with such cutting lines by means of the generated local pressure stress, wherein an automatic levelling happens. Ideally, during the following load cycles of the tool onto each section of the cutting rule the same pressure stress is applied, wherein a manual levelling can be omitted or if only very little levelling must be done.

Further, recesses extending transverse to the steel band can be introduced much easier and more exact than recesses which are otherwise arranged. According to the invention, they can be easily and cost-efficiently ground or milled into the back. Thereby, it has to be noted that cutting lines only have a very small thickness of below 1 mm, such that complex back shapes technologically and economically cannot be produced. Further, by means of these metal cutting kinds of processing it is ensured that nothing changes at the desired height of the cutting rule—that has to be ensured exactly—during the processing. Therefore, self-levelling cutting rules according to the invention can be produced very exactly and on the other hand very cost-efficiently.

In a preferred embodiment, the protrusions essentially comprise a height h of 0.5%-70% and even more preferred of essentially 2%-20% and more preferred of 6%-10% of the thickness D of the steel band. Surprisingly it was found out that for recesses that are introduced transverse to the steel band, only recesses with a comparably low height are required for automatic levelling. This of course has large advantages with respect to the stability of a cutting rule within the slot of the carrier plate.

In another aspect of the present invention, the above-mentioned problem is solved by a cutting rule comprising a steel band with a cutting edge and a back of the steel band opposite to the cutting edge, wherein the back is surface decarburized such that it can be plastically deformed during the first use of the cutting rule.

The plastic deformability of the back of a cutting rule which is desired for an automatic levelling according to the invention can also be guaranteed by surface decarburization of the back. This can be done for usual shapes of the back and also for shapes of the back with protrusions and recesses according to the other aspects of the invention, wherein the respective effects, particularly the plastic deformability of the back, can be increased.

For a surface decarburization carbon is withdrawn out of the steel in the area of the back by a diffusion process and thereby a soft ferric microstructure in the area of the back is generated that can easily be plastically deformed. Process technique wise, such a decarburization can be achieved if the edge area of the cutting rule is subjected to a reducing gas atmosphere at elevated temperatures.

By means of such cutting rules that are decarburized in the back area, the back area plastically deforms during the initial load of a tool with such cutting rules by appearing local pressure stresses, wherein an automatic levelling is done. Ideally, in the following load cycles of the tool then in each section of the cutting rule the same pressure stress appears, wherein a manual levelling can be omitted or a manual levelling must only be done to a very limited amount.

In a preferred embodiment, the back of the cutting rule is decarburized to a depth of 5 μm-100 μm.

In a further preferred embodiment, the back is rounded in a cross section through the tip of the protrusions. By this shape of the back, which is additionally rounded in transverse direction, a line or point-shaped abutting face of the back at the back plate of the tool is given, wherein the plastic deformation of the protrusions is further facilitated. Additionally, the introduction of the cutting rules into the slots of the carrier plate is facilitated. Finally, such a cross sectional shape further decreases the effect of the so called back bulging in small bending radiuses. During bending of small radiuses, usually an increase of the total height H of the cutting rule in a range of up to 0.2 mm would happen, depending on the thickness of the cutting rules and the bending radius, what is avoided according to the invention.

In another preferred embodiment, the back in a cross section through the tip of the protrusions is chamfered at both sides or double-concave shaped. Also these shapes of the back facilitate an exact defined measure of plastic deformation while providing sufficient stability of the back.

In a further preferred embodiment, the back in a cross section through the tip of the protrusions is semi-circular rounded, wherein the radius of the rounding r corresponds to the half thickness D of the steel band. This embodiment is particularly preferred with respect to the back bulging, wherein simultaneously a sufficiently high stability of the back of the grooving and cutting rule in transverse direction is provided. By means of the back, being rounded in transverse direction, quasi a central force introduction into the grooving or cutting rule is given, wherein transverse forces are avoided. Thereby, a tilting of the grooving or cutting rule within the slot of the carrier plate is effectively prevented.

In a further preferred embodiment, the protrusions in a longitudinal section through one tip of the protrusions comprise concave flanks. Further preferred, the back in a longitudinal section comprises recesses that are shaped like a segment of a circle, particularly a half circle with a radius. By means of the concave, particularly round flanks of the protrusions seen in longitudinal direction of the grooving and cutting rule, these protrusions comprise a progressive characteristic curve with respect to pressure forces introduced from above. This is particularly advantageous in order to ensure a plastic deformation and not only an elastic deformation of the protrusions at small height differences as well as also at large height differences to be levelled. Preferably, the radius of the recesses corresponds to 10%-250%, preferably 20%-150% and even more preferred essentially 100% of the thickness of the steel band.

Preferably, the protrusions in a longitudinal section through a tip of the protrusions comprise a tip that tapers to a point. In an extreme case, for example the radius of the flanges and the distance of the protrusions to each other is chosen such that a pointed tip of the protrusions results. Thereby, prior the first load a point-shaped contact between the protrusions and the protection plate of the tool is given, which after the load application will become a two-dimensional contact.

Preferably, the protrusions in a longitudinal section through a tip of the protrusions comprise a blunt tapered tip. Here, for example, the radius of the flanks and the distance of the protrusions are chosen such that a blunt tapered tip of the protrusions results. Thereby, prior the first load application a line-shaped contact between the protrusions and the protection plate of the tool results, which becomes a two-dimensional contact after the load application.

In a preferred embodiment, the blunt tapered tip comprises a length l of 1%-50%, preferably 5%-30% and more preferred of 20% of the thickness D of the steel band.

Preferably, the back was tempered and/or soft-annealed and/or surface decarburized, in order to increase its plastic deformability. By the tempering or likewise by a partial soft-annealing or by the surface decarburization a plastic deformability of the back is increased and, thereby, the cutting edge is preserved due to lower compression forces during the automatic levelling.

The above-mentioned problems are also solved by the use of one of the above described cutting rules within a stamping machine, particularly a flat bed stamping machine or a rotational stamping machine.

### 4. SHORT DESCRIPTION OF THE DRAWINGS

In the following, preferred embodiments of the invention are described with respect to the drawings. It shows:

FIG. 1: an enlarged sectional view of a cutting rule according to the invention;

FIG. 2: a detailed view of FIG. 1, that shows the upper part of a cutting rule according to the invention in a condition cut in transverse direction Q along the line A-A of FIG. 3;

FIG. 3: a detailed view of the side of one embodiment of a cutting or grooving rule according to the invention in a condition cut in longitudinal direction L along the line B-B of FIG. 2;

FIG. 4: a detailed view of a further embodiment of a grooving or cutting rule according to the invention in a condition cut in longitudinal direction L along the line B-B of FIG. 2;

FIG. 5: a detailed view of the upper part of a cutting rule according to the invention in a condition cut in transverse direction Q with a slanted shape of the back on both sides;

FIG. 6: a detailed view of the upper part of a cutting rule according to the invention in a condition cut in transverse direction Q with a double-concave shape of the back;

FIG. 7: a combined side view (to the left) and cut view in transverse direction (to the right) of a further embodiment of the cutting rule according to the invention; and

FIGS. 8 and 9: microscopic detailed views of back portions cut in longitudinal direction of cutting rules according to the invention.

### 5. DESCRIPTION OF PREFERRED EMBODIMENTS

In the following, preferred embodiments of the present invention are described in detail with reference to the figures.

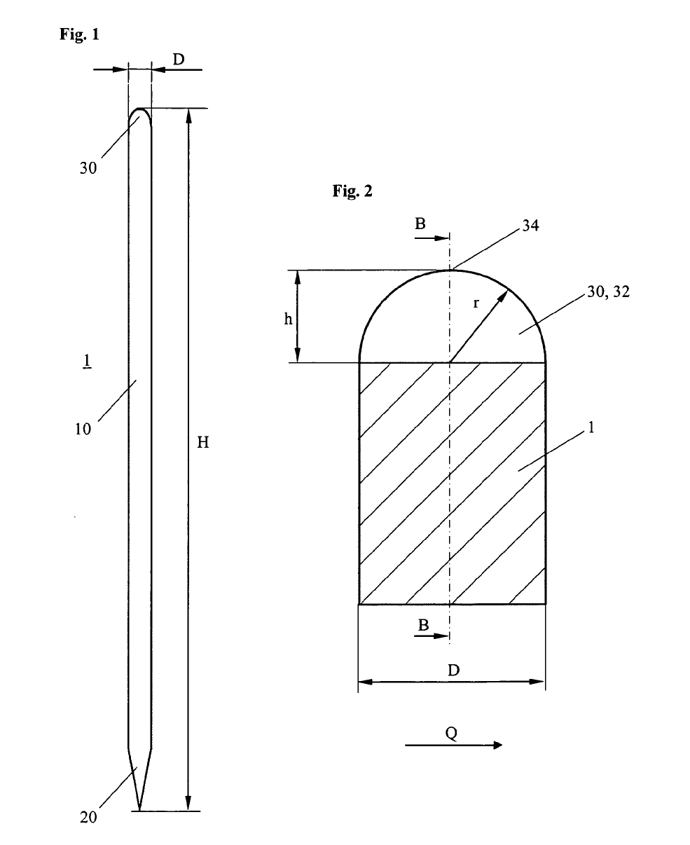

FIG. 1 shows a first embodiment of a cutting rule 1 according to the invention. The cutting rule 1 essentially consists of a flat steel band 10 with a height H in the range of approximately 8 to 100 mm, a thickness D in the range of 0.45 to 2.13 mm (1.3 to 6 pt), an arbitrary length and a cutting edge 20. Special geometries of the cutting rules—as mentioned above—have other edge shapes 20 and are also subject matter of the present invention.

Opposed to the cutting edge 20, there is the back 30 of the steel band 10, respectively of the cutting rule 1, which in a preferred embodiment is rounded. In the shown embodiment, the back 30 is semi-circular rounded and has a rounding radius r which corresponds essentially to half of the thickness D of the steel band 10.

In FIG. 2, a section through the area of the back 30 is shown in detail. Here, particularly the semi-circular rounding in a cross section of the back area 30 is shown particularly well. The rounding of the back area 30 is produced by grinding or scraping of the steel band 10, similarly to the facets of the cutting edge area 20.

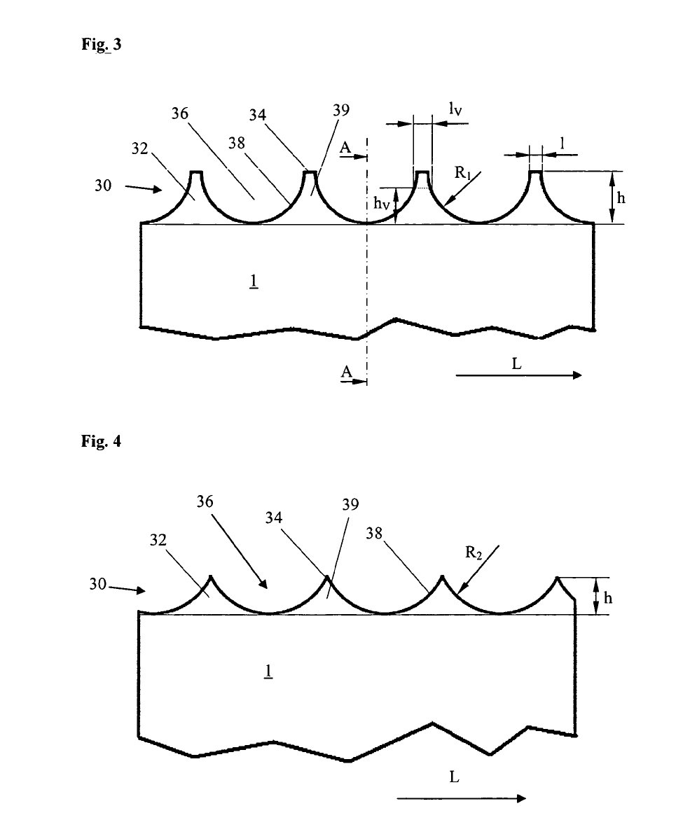

FIG. 3 shows the back area of the steel band in a side view. One can note that the back comprises protrusions 32, which are produced in that recesses 36 are ground into the back. In the preferred embodiment of FIG. 3, the back in a longitudinal section comprises semi-circular recesses 36, which comprise a radius R₁. The radius R₁ in one embodiment can be in the range of the half of the thickness D of the steel band 10.

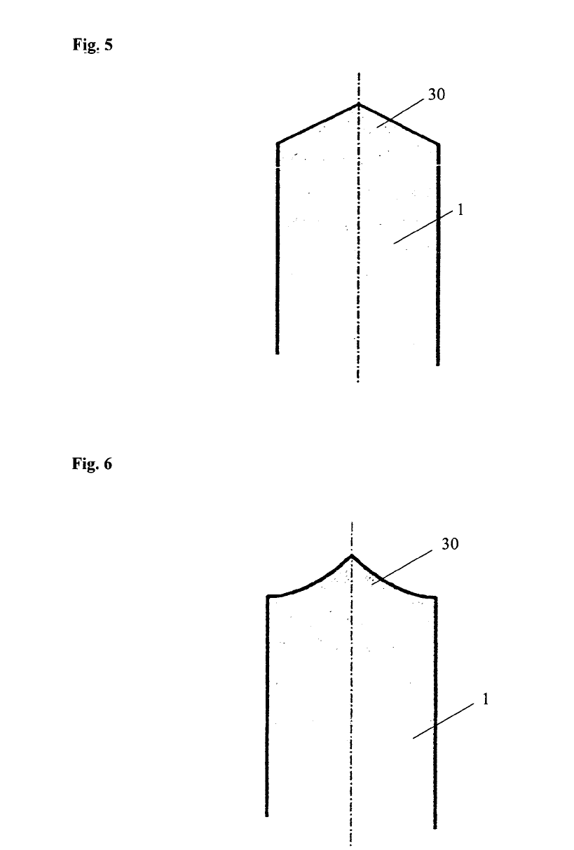

In other embodiments shown in FIGS. 5 and 6, the back 30 in its cross section is tapered on both sides or shaped double-concave.

The distance between the recesses 36 was chosen such that a blunt tapering tip 34 of the protrusions 32 results, which, thereby, comprises a length l. Preferably, the length l constitutes 1%-20% of the thickness D of the steel band 10 and in one embodiment, it constitutes 0.05-0.15 mm, preferably 0.08 mm-0.13 mm and particularly preferred 0.11 mm.

In the embodiment shown in FIG. 3, the height h constitutes approximately 0.35 mm and thereby approximately 50% of the thickness D of the steel band 10 of 0.71 mm.

In FIG. 4, another preferred embodiment of the back area of the source material 1 for cutting rules is shown. In this embodiment, the radius R₂ was chosen larger than the radius R₁ of the recesses 36 of FIG. 3. Thereby, a pointed tapering tip 34 of the protrusions 32 results and a smaller height h of the protrusions 32. The radius R₂ may preferably be in the range of the thickness D of the steel band 10. Preferably, the radius R₂ corresponds to 50% to 150% and more preferred of essentially 100% of the thickness D of the steel band 10.

During the first use of the source material 1 as grooving or cutting rule according to the invention, the back area 30 of the steel band 10 deforms. At areas of high load of the grooving or cutting rule, the steel band 10 initially deforms elastically and while exceeding the elastic limit also plastically, particularly first in the area of the highest compression load. For the source material 1 according to the invention, the areas of the highest loads are the tips 34 of the protrusions 32. The protrusions 32, therefore, act initially as elastic springs. While exceeding the elastic limit in this local area, they will deform plastically, i.e. they are compressed in a plastic way and, therefore, provide for the automatic levelling. This plastic change of the height is shown in FIG. 3 by the height h_{V} after the deformation. During compression of the protrusions 34 also the length of the blunt tip increases from l to l_{V}.

The same applies for a grooving and cutting rule according to the embodiment of FIG. 4. During the first use, the protrusions 32 at their tip are plastically deformed, such that they become more flat and after the deformation have a height h_{V} and a blunt tapering tip 34 with a length l_{V}.

By means of the preferred concave flanges 38 in longitudinal direction of the grooving and cutting rule and the—in transverse direction—semi-circular, respectively convex flanks 39 of the protrusions 32, a progressive force-way characteristic curve results, which allows a levelling over a large range and nevertheless provides the required stability in order to guarantee a perfect cutting or grooving result.

This is particularly true for the area of the radius of the bending if the grooving or cutting rules must be bent or folded. Particularly in this area a smaller effect of back bulging appears, which would lead to an increased pressure in this area.

By means of the ground or milled recesses, the contact face between the back 30 and the back plate of the stamping machine is lowered, wherein the contact tensions compared to common shapes of the back are heavily increased. Thereby, it is ensured that during the first use, at the tips 34—which are subjected to the highest load—such a high contact tension appears, which causes a plastic deformation in this area without a plastic deformation of the steel band 10 and particularly the cutting or grooving edge 20. Thereby, a height reduction of the height H of the steel band 10 results and correspondingly an automatic levelling of the cutting rules.

Moreover, by means of the rounding of the back in the cross section the grooving or cutting rule can be easily introduced into slots in the carrier plate made by a laser.

Other back shapes are also conceivable, which may also have in their cross section areas with straight or concave contours which further increase the progressiveness of the plastic resistance.

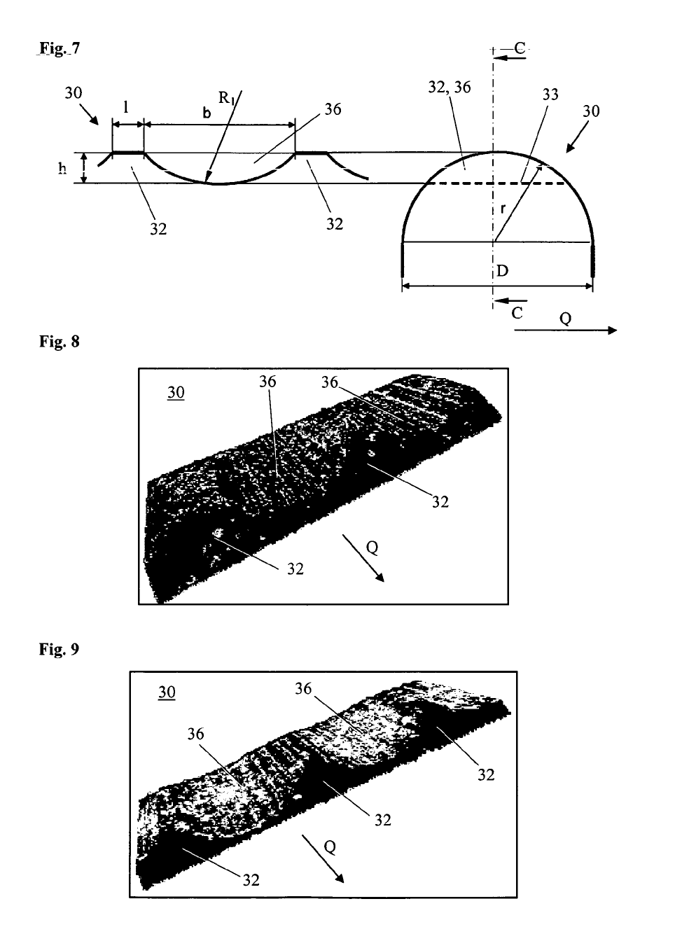

FIG. 7 shows a further preferred embodiment of a back 30 of a cutting rule 1, wherein the height h of the protrusions is lower than in the embodiment of FIG. 3. Particularly, this embodiment shows a back that is rounded in its section by a radius r, which corresponds to the half of the thickness D of the cutting rule 1.

The dashed line 33 in the right part of FIG. 7 shows that the recesses 36 and the protrusions 32 are only located in the upper part of the rounded area of the back 30.

In this embodiment, two samples were produced, which during use in a stamping machine showed a sufficient self-levelling effect. The cutting rules had the following dimensions:

| | Sample I | Sample II |
|---|---|---|
| D | 0.71 mm | 0.71 mm |
| r | 0.35 mm | 0.35 mm |
| t | 45 μm | 75 μm |
| b | 345 μm | 485 μm |
| l | 145 μm | 5 μm |

In FIG. 8, a microscopic sectional view of sample I along line C-C of FIG. 7 is shown. In FIG. 9, a microscopic sectional view of sample II along the line C-C of FIG. 7 is shown. By means of the microscopic scratches in transverse direction Q one can see that the recesses 36 have been ground by a thin grinding plate (thickness of the grinding plate approximately 0.5 mm).

In order to increase the plastic deformability of the back 30, the back is tempered or even partially soft-annealed after the hardening step of the source material 1.

Alternatively or additionally to the above-described embodiments, an automatic levelling can also be done by means of a cutting rule, whose back is surface decarburized up to a depth of 5 μm to 100 μm. The surface decarburized ferric material of the back area is comparably soft and can easily be plastically deformed, what again leads to an automatic levelling during the first use of such cutting rules. The maximum possible levelling can be adjusted via the depth of the surface decarburization and, therefore, the cutting rule can be adapted to different use cases.

Of course it is also possible to additionally surface decarburize the above-described cutting rule in the back area with protrusions and recesses in the back in order to further increase the plastic deformability.

Such cutting rules can be used in stamping machines, particularly in a flat bed stamping machine or in a rotational stamping machine. Due to the specific design and dimensioning of the protrusions 32 of the back 30, a cutting rule 1 for stamping tools is provided, which for the first time can be used in practice and which significantly reduces the effort for the time and cost consuming manual levelling.

Preferably, the source material 1 comprises of a tool steel and comprises a central cutting edge with single plane facets (CF). Other cutting edge and facet shapes are also possible. Usual cutting edge angles are in the range of 30° and 60°. The facets have been scraped or ground and the cutting edge was CF or HF hardened in a usual way.

1. Cutting rule (1) comprising:
a. a steel band (10) having a cutting edge (20);
b. a back (30) of the steel band opposite to the cutting edge (20); wherein
c. the back (30) comprises protrusions (32), which can plastically be deformed during the first use of the cutting rule (1); and
d. the protrusions (32) essentially comprise a height (h) of 30%-70% of the thickness (D) of the steel band (10).

2. Cutting rule according claim 1, wherein the protrusions (32) essentially comprise a height (h) of 40%-60% and preferably of essentially 50% of the thickness (D) of the steel band (10).

3. Cutting rule according claim 1 or 2, wherein the protrusions (32) were generated by grinding or milling of recesses (36) into the back (30) in trans-verse direction (Q) of the steel band (10).

4. Cutting rule 1 comprising:
a. a steel band (10) with a cutting edge (20);
b. a back (30) of the steel band (10) opposite to the cutting edge (20); wherein
c. the back (30) comprises protrusions (32), which can plastically be deformed during the first use of the cutting rule (1), wherein
d. the protrusions (32) were generated by milling or grinding of recesses (36) into the back (30) in transverse direction (Q) of the steel band (10).

5. Cutting rule according claim 4, wherein the protrusions (32) essentially comprise a height (h) of 0.5%-70% and preferably of essentially 2%-20% and more preferred of 6%-10% of the thickness (D) of the steel band (10).

6. Cutting rule 1 comprising:
a. a steel band (10) with a cutting edge (20);
b. a back (30) of the steel band (10) opposite to the cutting edge (20); wherein
c. the back (30) is surface decarburized such that it can plastically be deformed during the first use of the cutting rule (1).

7. Cutting rule according to one of the claims 1-6, wherein the back (30) is surface decarburized up to a depth of 5 μm to 100 μm.

8. Cutting rule according to one of the claims 1-7, wherein the back (30) is rounded in a cross section through a tip (34) of the protrusions (32) or wherein the back (30) in a cross section through a tip (34) of the protrusions (32) is chamfered at both sides or shaped double-concave.

9. Cutting rule according one of the claims 1-8, wherein the back (30) in a cross section through a tip (34) of the protrusions (32) is rounded semicircular, wherein the radius (r) of the rounding corresponds essentially to the half of the thickness (D) of the steel band (10).

10. Cutting rule according one of the claims 1-9, wherein the protrusions (32) in a longitudinal section through a tip (34) of the protrusions (32) comprise concave flanks (38).

11. Cutting rule according one of the claims 3-9, wherein the recesses (36) in a longitudinal section are formed like a section of a circle, particularly semicircular with a radius (R₁, R₂).

12. Cutting rule according claim 11, wherein the radius (R₂) of the recesses (36) corresponds to 10%-250%, preferably 20%-150% and more preferred to essentially 100% of the thickness (D) of the steel band (10).

13. Cutting rule according to one of the claims 1-12, wherein the protrusions (32) in a longitudinal section through a tip (34) of the protrusions (32) comprise a pointed tapering tip (34) or a blunt tapering tip (34) with a length (l) of 1%-50%, preferably 5%-30% and more preferred of 20% of the thickness (D) of the steel band (10).

14. Cutting rule according to one of the claims 1-13, wherein the back (30) is tempered and/or is soft-annealed and/or is surface decarburized in order to increase the plastic deformability.

15. Use of a cutting rule (1) according to one of the claims 1-14 in a stamping machine, particularly in a flat bed stamping machine or in a rotational stamping machine.
